(19) United States
(12) Patent Application Publication
(10) Pub. No.: US 2024/0193479 A1
(43) Pub. Date: Jun. 13, 2024

(54) COMPUTER-READABLE RECORDING MEDIUM STORING MACHINE LEARNING PROGRAM, MACHINE LEARNING METHOD, AND MACHINE LEARNING DEVICE

(71) Applicant: Fujitsu Limited, Kawasaki-shi (JP)

(72) Inventors: Masahiro ASAOKA, Kawasaki (JP); Tsuguchika TABARU, Machida (JP)

(73) Assignee: Fujitsu Limited, Kawasaki-shi (JP)

(21) Appl. No.: 18/461,555

(22) Filed: Sep. 6, 2023

(30) Foreign Application Priority Data
Dec. 8, 2022 (JP) 2022-196652

(51) Int. Cl. G06N 20/00

(52) U.S. Cl. CPC G06N 20/00

(57) ABSTRACT

A non-transitory computer-readable recording medium stores a machine learning program for causing a computer to execute processing including: causing each of a plurality of machine learning processes to perform individual machine learning by the same machine learning model; storing data after execution of first processing by each of the machine learning processes in a shared memory accessible by each of the machine learning processes; and causing a second machine learning process other than the first machine learning process among the plurality of machine learning processes to execute second processing regarding the first machine learning process, based on first data after the execution of the first processing regarding the first machine learning process, stored in the shared memory, in a case where an abnormality occurs at the time of execution of the second processing executed after the first processing by the first machine learning process among the machine learning processes.

### CROSS-REFERENCE TO RELATED APPLICATION

This application is based upon and claims the benefit of priority of the prior Japanese Patent Application No. 2022-196652, filed on Dec. 8, 2022, the entire contents of which are incorporated herein by reference.

### FIELD

The embodiment discussed herein is related to a machine learning program, a machine learning method, and a machine learning device.

### BACKGROUND

In recent years, researches and developments of deep learning (deep learning) have been rapidly advanced, and application to various fields such as image recognition, character recognition, voice recognition, smartphones, autonomous robots, or drones has been expected. In the deep learning, training is performed using a deep neural network (DNN) such as a convolutional neural network (CNN).

International Publication Pamphlet No. WO 2021/111586 is disclosed as related art.

### SUMMARY

According to an aspect of the embodiments, a non-transitory computer-readable recording medium stores a machine learning program for causing a computer to execute processing including: causing each of a plurality of machine learning processes to perform individual machine learning by the same machine learning model; storing data after execution of first processing by each of the machine learning processes in a shared memory accessible by each of the machine learning processes; and causing a second machine learning process other than the first machine learning process among the plurality of machine learning processes to execute second processing regarding the first machine learning process, based on first data after the execution of the first processing regarding the first machine learning process, stored in the shared memory, in a case where an abnormality occurs at the time of execution of the second processing executed after the first processing by the first machine learning process among the machine learning processes.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a parallel distributed machine learning system according to an embodiment;

FIG. 2 is a diagram illustrating an outline of registration of processing results of forward propagation training, backpropagation training, and parameter update processing in a shared memory;

FIG. 3 is a diagram illustrating an operation at the time when a process abnormality occurs;

FIG. 4 is a flowchart of machine learning by the parallel distributed machine learning system according to the embodiment; and

FIG. 5 is a hardware configuration diagram of a computer.

### DESCRIPTION OF EMBODIMENTS

Here, since the number of weighting coefficients is enormous in training using a machine learning model, training needs long time. Therefore, in training using a large-scale deep neural network, it is desirable to introduce parallel distributed processing for distributedly performing update of training data and weighting coefficients with a plurality of calculation nodes.

In the parallel distributed processing, each calculation node has the same training data in a memory so as to operate a machine learning system with high efficiency. However, since an overall data amount to be used in large-scale training is large, there is a possibility that the memory of each calculation node is insufficient. Therefore, a method called data distribution for distributing training data to be placed on the memory of each calculation node has been proposed.

Note that, in typical machine learning, snapshots are frequently left at predetermined check points, for example, for at each training cycle, and processing is proceeded so as to restart training from the immediately preceding check point even if a machine learning process stops in the middle. Furthermore, as the parallel distributed processing technology, technology has been proposed for transferring data of a job by direct memory access, to a shared memory region shared by a plurality of jobs held by each calculation node, after calculation of the job is completed.

Although the typical parallel distributed processing can restart training from the check point, since a progress from the check point to a failure occurrence is not held, there is a possibility that a data loss occurs, entire training processing stops, and a training time increases. Furthermore, a method for increasing the number of check points in order to prevent the data loss is considered, but this method is not realistic because a saving time of snapshots and a storage capacity increase.

The disclosed technology has been made in view of the above, and an object is to provide a machine learning program, a machine learning method, and a machine learning device that improve training efficiency of machine learning.

Hereinafter, an embodiment of a machine learning program, a machine learning method, and a machine learning device disclosed in the present application will be described in detail with reference to the drawings. Note that the following embodiment does not limit the machine learning program, the machine learning method, and the machine learning device disclosed in the present application.

### Embodiment

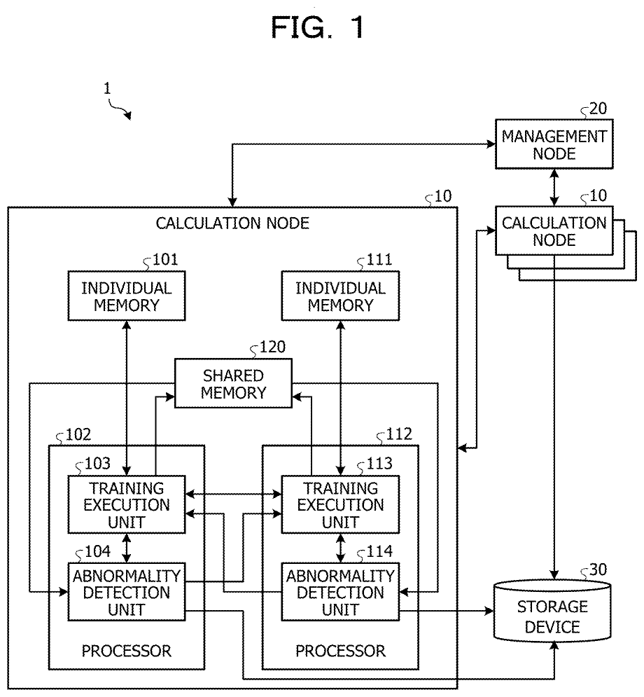

FIG. 1 is a block diagram of a parallel distributed machine learning system according to an embodiment. A parallel distributed machine learning system 1 according to the embodiment includes a plurality of calculation nodes 10, a management node 20, and a storage device 30. The management node 20 and each calculation node 10 are coupled with a network. Furthermore, the respective calculation nodes 10 are coupled to each other with the network. Furthermore, each calculation node 10 is coupled to the storage device 30. Note that the parallel distributed machine learning system 1 is an example of a computer.

The management node 20 performs centralized management of machine learning by parallel distributed processing. Any one of the calculation nodes 10 may have a function of the management node 20. The management node 20 receives input of training data from a user via an external terminal device (not illustrated) or the like. Furthermore, the management node 20 receives input of training data used to train a machine learning model in advance.

Then, the management node 20 transmits the machine learning model to be trained to each calculation node 10 and distributes the same machine learning model to each calculation node 10. Furthermore, the management node 20 transmits and distributes the training data to each calculation node 10. At this time, the management node 20 spreads the training data and distributes the training data to each calculation node 10. For example, the management node 20 may distribute different training data to each calculation node 10. Furthermore, the management node 20 may distribute a different training node, for each group of one or two or more calculation nodes 10.

When machine learning is completed to a final cycle, the management node 20 receives the trained machine learning model from the calculation node 10. Then, the management node 20 outputs the acquired trained machine learning model to a device that performs inference or the like.

Regarding the storage device 30, a snapshot of the machine learning model for each check point is stored by each calculation node 10. Furthermore, regarding the storage device 30, at the time when a process abnormality of a machine learning process occurs, a snapshot of a machine learning model at a processing completion time of the machine learning process of forward propagation training, backpropagation training, or parameter update processing, whichever is completed later is stored by each calculation node 10. The snapshot held by the storage device 30 is used to restart the machine learning from a time point when the snapshot is created.

Each calculation node 10 performs calculation in the machine learning using the machine learning model. Then, each calculation node 10 updates a model parameter of the machine learning model, based on a training result obtained by each calculation node 10. Hereinafter, details of the calculation node 10 will be described.

As illustrated in FIG. 1, the calculation node 10 includes individual memories 101 and 111, processors 102 and 112, and a shared memory 120.

The individual memory 101 is a main storage device allocated to the processor 102 and is used for calculation processing by the processor 102. The individual memory 111 is a main storage device allocated to the processor 112 and is used for calculation processing by the processor 112.

The processor 102 and the individual memory 101, and the processor 112 and the individual memory 111 respectively execute machine learning processes different from each other using different pieces of training data. In FIG. 1, the two processors 102 and 112 are described for the single calculation node 10. However, the number of processors may be equal to or more than three.

The shared memory 120 is a memory shared by both of the processors 102 and 112. Both of the processors 102 and 112 can read and write data from and into the shared memory 120. The individual memories 101 and 111 and the shared memory 120 may be different partial regions on the same memory, not physically different memories.

The processor 102 includes a training execution unit 103 and an abnormality detection unit 104. Furthermore, the processor 112 includes a training execution unit 113 and an abnormality detection unit 114. Since the processors 102 and 112 have the same function, the processor 102 and the individual memory 101 will be described below as an example.

The training execution unit 103 holds the machine learning model transmitted from the management node 20. Furthermore, the training execution unit 103 holds the training data transmitted from the management node 20. The training execution unit 103 may cause the individual memory 101 to hold the machine learning model and the training data.

The training execution unit 103 performs forward propagation calculation and forward propagation training using the machine learning model and the training data. When the forward propagation training is completed, the training execution unit 103 records information regarding a loss of forward propagation that is a result obtained through the forward propagation training, in the shared memory 120. Here, in a case where a process abnormality of the machine learning process caused by a failure of the individual memory 101 or the like occurs during the execution of the forward propagation training, the training execution unit 103 stops the machine learning.

Next, the training execution unit 103 performs backpropagation calculation and backpropagation training using the machine learning model and the results of the forward propagation training. When the backpropagation training is completed, the training execution unit 103 records information regarding a gradient of the backpropagation that is a result obtained through the backpropagation training, in the shared memory 120. Here, in a case where a process abnormality of the machine learning process occurs during the execution of the backpropagation training, the training execution unit 103 stops the training.

Next, the training execution unit 103 communicates with the training execution unit 113 of the own node and the training execution units 103 and 113 of another calculation node 10 and shares the results of the forward propagation training and the backpropagation training. Thereafter, the training execution unit 103 executes the parameter update processing such as update of the model parameter of the machine learning model, using the shared results of the forward propagation training and the backpropagation training. When the parameter update processing is completed, the training execution unit 103 records an optimizer state and the model parameter that are the results of the parameter update processing, in the shared memory 120. Here, in a case where a process abnormality of the machine learning process occurs during the execution of the parameter update processing, the training execution unit 103 stops the training.

When the forward propagation training, the backpropagation training, and the parameter update processing are completed, the training execution unit 103 determines whether or not a check point save cycle has arrived. The check point save cycle is a periodic period in which a snapshot is held and a check point to be a starting point of restart of machine learning is generated. The check point save cycle is, for example, set with reference to a training cycle such as one iteration or one epoch in machine learning.

When the check point save cycle has not arrived, the training execution unit 103 repeats the forward propagation training, the backpropagation training, and the parameter update processing. On the other hand, in a case where the check point save cycle has arrived, the training execution unit 103 generates the snapshot of the generated machine learning model and stores the snapshot in the storage device 30.

The snapshot is information representing a machine learning model and may include, for example, information regarding an intermediate layer configuring the machine learning model and information regarding a weight, an activity, a gradient, or the like obtained through training. The snapshot represents a machine learning model at the time when the snapshot is created, and the calculation node 10 can reproduce the machine learning model at the time when the snapshot is created, by using the snapshot.

After the generation of the check point, the training execution unit 103 repeats to execute the forward propagation training, the backpropagation training, and the parameter update processing before the next check point save cycle arrives. Then, when a final cycle of the machine learning has arrived, the training execution unit 103 ends the machine learning. Thereafter, the training execution unit 103 transmits the trained machine learning model to the management node 20. However, it is sufficient that the transmission of the trained machine learning model to the management node 20 be performed by the training execution unit 103 of any one of the calculation nodes 10.

The abnormality detection unit 104 start to monitor operations of the training execution units 103 and 113, at the time when the machine learning is started by the training execution unit 103. As a result, the abnormality detection unit 104 starts to monitor a state of the machine learning process executed by both of the processors 102 and 112. Here, it is sufficient that the abnormality detection unit 104 monitor at least the state of the machine learning process of the processor 112 that shares the shared memory 120 with the processor 102, and the abnormality detection unit 104 does not need to monitor the state of the machine learning process of the processor 102. Then, the abnormality detection unit 104 detects occurrence of a process abnormality of the machine learning process caused by a failure of the individual memories 101 and 111 or the like, in the series of machine learning including the forward propagation training, the backpropagation training, and the parameter update processing.

In a case where the process abnormality of the machine learning process executed by the processor 112 while the forward propagation training by the training execution unit 113 is executed is detected, the abnormality detection unit 104 acquires data of the machine learning process executed by the processor 112, from the shared memory 120. The data of the machine learning process includes the information regarding the loss of the forward propagation, the information regarding the gradient of the backpropagation, and the optimizer state and the model parameter. Next, the abnormality detection unit 104 generates the snapshot of the machine learning model at the completion time of the forward propagation training, the backpropagation training, or the parameter update processing, whichever comes closest to the abnormality occurrence time point, using the data of the machine learning process executed by the processor 112 and the machine learning model. Hereinafter, the completion time point of the forward propagation training, the backpropagation training, or the parameter update processing, whichever comes closest to the abnormality occurrence time point, for example, the time point when the data is most recently stored in the shared memory 120 is referred to as a “time point closest to the abnormality occurrence”.

Furthermore, the abnormality detection unit 104 acquires the data of the machine learning process executed by the processor 102 from the shared memory 120 and acquires the snapshot. Thereafter, the abnormality detection unit 104 stores the snapshot of the machine learning model at the time point closet to the abnormality occurrence in each of the processors 102 and 112, in the storage device 30. In this case, the abnormality detection units 104 and 114 of another calculation node 10 acquire the snapshots of the machine learning model at the time point closest to the abnormality occurrence in the respectively corresponding processors 102 and 112 and store the snapshots in the storage device 30.

Thereafter, for example, the abnormality detection unit 104 notifies the management node 20 of the occurrence of the process abnormality in the machine learning process executed by the training execution unit 113 of the processor 112. The management node 20 receives the notification and acquires a snapshot of the machine learning model in each machine learning process at the time point closest to the abnormality occurrence, from the storage device 30. Then, the management node 20 transmits each acquired snapshot to each calculation node 10 and causes each calculation node 10 to restart the machine learning from the time point closest to the abnormality occurrence.

Here, the forward propagation training, the backpropagation training, and the parameter update processing are examples of “first processing”. Then, in a case where the forward propagation training is assumed as the “first processing”, the backpropagation training is an example of “second processing”. Furthermore, in a case where the backpropagation training is assumed as the “first processing”, the parameter update processing is an example of the “second processing”. Furthermore, in a case where the parameter update processing is assumed as the “first processing”, the forward propagation training is an example of the “second processing”.

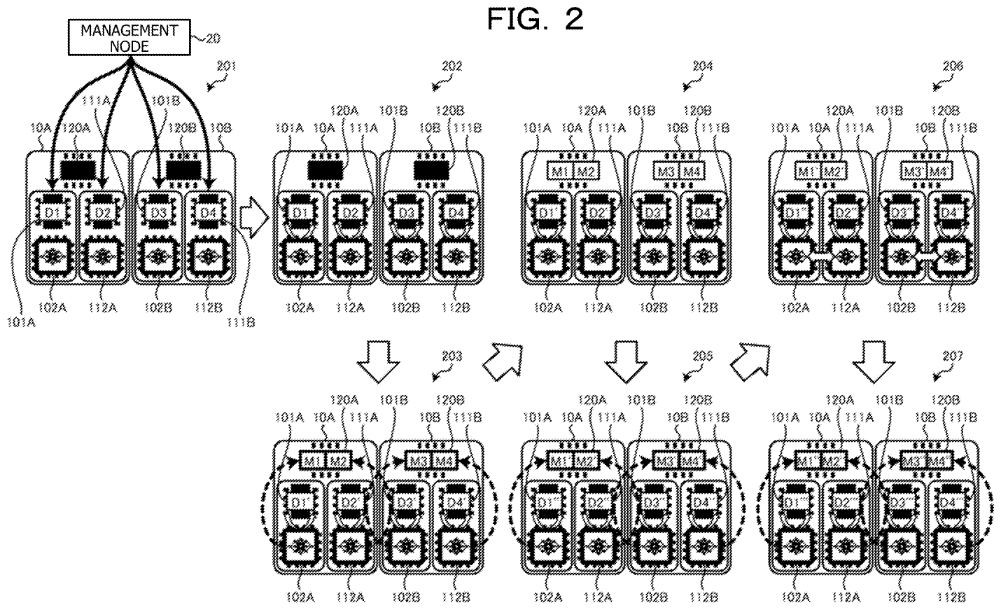

FIG. 2 is a diagram illustrating an outline of registration of processing results of the forward propagation training, the backpropagation training, and the parameter update processing, in a shared memory. Next, operations of the training execution unit 103 in the forward propagation training, the backpropagation training, and the parameter update processing will be collectively described with reference to FIG. 2.

Here, calculation nodes 10A and 10B will be described. The calculation node 10A includes a shared memory 120A, individual memories 101A and 111A, and processors 102A and 112A. Furthermore, the calculation node 10B includes a shared memory 120B, individual memories 101B and 111B, and processors 102B and 112B.

A state 201 indicates a state of the calculation nodes 10A and 10B at the start of machine learning. Each of the calculation nodes 10A and 10B acquires a machine learning model and distributed training data from the management node 20. In this case, data D1 is stored in the individual memory 101A, data D2 is stored in the individual memory 111A, data D3 is stored in the individual memory 101B, and data D4 is stored in the individual memory 111B. Then, each of the processors 102A, 112A, 102B, and 112B starts machine learning using the acquired training data.

A state 202 indicates a state of the calculation nodes 10A and 10B at the time of forward propagation training. The processor 102A performs forward propagation calculation using the data D1 stored in the individual memory 101A. Then, the processor 102A stores data D1′ including a result of the forward propagation training in the individual memory 101A. The processor 112A performs forward propagation calculation using the data D2 stored in the individual memory 111A. Then, the processor 112A stores data D2′ including a result of the forward propagation training in the individual memory 111A. The processor 102B performs forward propagation calculation using the data D3 stored in the individual memory 101B. Then, the processor 102B stores data D3′ including a result of the forward propagation training in the individual memory 101B. The processor 112B performs forward propagation calculation using the data D4 stored in the individual memory 111B. Then, the processor 112B stores data D4′ including a result of the forward propagation training in the individual memory 111B.

A state 203 indicates a state of the calculation nodes 10A and 10B after the forward propagation training ends. When the forward propagation training ends, the processor 102A records information regarding a loss of forward propagation obtained through the forward propagation training in the shared memory 120A and causes the shared memory 120A to hold data M1. Furthermore, the processor 112A records information regarding a loss of forward propagation obtained through the forward propagation training in the shared memory 120A and causes the shared memory 120A to hold data M2. Furthermore, the processor 102B records information regarding a loss of forward propagation obtained through the forward propagation training in the shared memory 120B and causes the shared memory 120B to hold data M3. Furthermore, the processor 112B records information regarding a loss of forward propagation obtained through the forward propagation training in the shared memory 120B and causes the shared memory 120B to hold data M4.

A state 204 indicates a state of the calculation nodes 10A and 10B at the time of backpropagation training. The processor 102A performs backpropagation calculation using the data D1′ stored in the individual memory 101A. Then, the processor 102A stores data D1″ including a result of the backpropagation training in the individual memory 101A. The processor 112A performs backpropagation calculation using the data D2′ stored in the individual memory 111A. Then, the processor 112A stores data D2″ including a result of the backpropagation training in the individual memory 111A. The processor 102B performs backpropagation calculation using the data D3′ stored in the individual memory 101B. Then, the processor 102B stores data D3″ including a result of the backpropagation training in the individual memory 101B. The processor 112B performs backpropagation calculation using the data D4′ stored in the individual memory 111B. Then, the processor 112B stores data D4″ including a result of the backpropagation training in the individual memory 111B.

A state 205 indicates a state of the calculation nodes 10A and 10B after the backpropagation training ends. When the backpropagation training ends, the processor 102A records information regarding a gradient of backpropagation obtained through the backpropagation training in the shared memory 120A and causes the shared memory 120A to hold data M1′. Furthermore, the processor 112A records information regarding a gradient of backpropagation obtained through the backpropagation training in the shared memory 120A and causes the shared memory 120A to hold data M2′. Furthermore, the processor 102B records information regarding a gradient of backpropagation obtained through the backpropagation training in the shared memory 120B and causes the shared memory 120B to hold data M3′. Furthermore, the processor 112B records information regarding a gradient of backpropagation obtained through the backpropagation training in the shared memory 120B and causes the shared memory 120B to hold data M4′.

A state 206 indicates a state of the calculation nodes 10A and 10B at the time of the parameter update processing. The processors 102A, 112A, 102B, and 112B share the results of the forward propagation training and the backpropagation training thereof. Next, the processor 102A updates a parameter of the machine learning model held by using the shared data. Then, the processor 102A stores data D1′″ including a result of the parameter update in the individual memory 101A. The processor 112A updates a parameter of the machine learning model held by using the shared data. Then, the processor 112A stores data D2′″ including a result of the parameter update in the individual memory 111A. The processor 102B updates a parameter of the machine learning model held by using the shared data. Then, the processor 102B stores data D3′″ including a result of the parameter update in the individual memory 101B. The processor 112B updates a parameter of the machine learning model held by using the shared data. Then, the processor 112B stores data D4′″ including a result of the parameter update in the individual memory 111B.

A state 207 indicates a state of the calculation nodes 10A and 10B after the parameter update processing ends. When the parameter update processing ends, the processor 102A records an optimizer state and a model parameter obtained by the parameter update processing in the shared memory 120A and causes the shared memory 120A to hold data M1″. Furthermore, the processor 112A records an optimizer state and a model parameter obtained by the parameter update processing in the shared memory 120A and causes the shared memory 120A to hold data M2″. Furthermore, the processor 102B records an optimizer state and a model parameter obtained by the parameter update processing in the shared memory 120B and causes the shared memory 120B to hold data M3′″. Furthermore, the processor 112B records an optimizer state and a model parameter obtained by the parameter update processing in the shared memory 120B and causes the shared memory 120B to hold data M4′″.

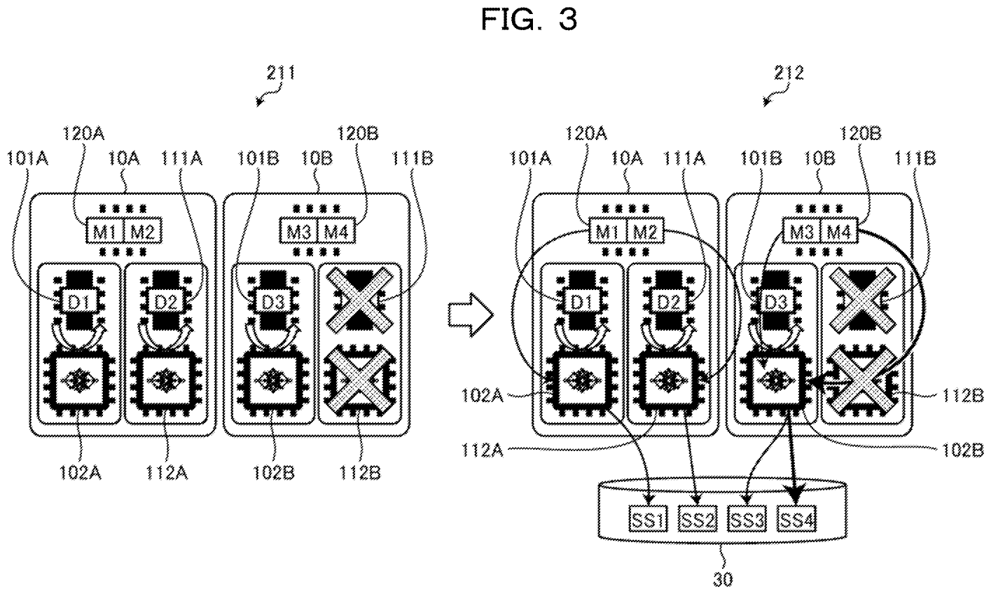

FIG. 3 is a diagram illustrating an operation at the time when a process abnormality occurs. A state 211 indicates a state of the calculation nodes 10A and 10B in which the process abnormality has occurred. Furthermore, a state 212 indicates a state of the calculation nodes 10A and 10B after the process abnormality has occurred. Furthermore, here, a case will be described where the shared memory 120A holds the data M1 and M2 and the shared memory 120B holds the data M3 and M4.

As indicated in the state 211, a case will be described where a process abnormality occurs in a machine learning process executed by the processor 112B and the individual memory 111B. In this case, the machine learning process executed by the processor 112B and the individual memory 111B stops.

Then, as indicated in the state 212, the processor 102B that shares the shared memory 120B with the processor 112B acquires the data M4 stored in the shared memory 120B. Then, the processor 102B generates a snapshot SS4 of the machine learning model using the acquired data M4 and the machine learning model and stores the snapshot SS4 in the storage device 30. Furthermore, the processor 102B acquires the data M3 stored in the shared memory 120B. Then, the processor 102B generates a snapshot SS3 of the machine learning model using the acquired data M3 and the machine learning model and stores the snapshot SS3 in the storage device 30. Similarly, the processor 102A acquires the data M1 stored in the shared memory 120A. Then, the processor 102A generates a snapshot SS1 of the machine learning model using the acquired data M1 and the machine learning model and stores the snapshot SS1 in the storage device 30. Furthermore, the processor 112A acquires the data M2 stored in the shared memory 120A. Then, the processor 112A generates a snapshot SS2 of the machine learning model using the acquired data M2 and the machine learning model and stores the snapshot SS2 in the storage device 30.

In this way, in a case where a process abnormality occurs in a machine learning process, another machine learning process generates a snapshot of the machine learning model at the time immediately before the abnormality occurrence using data of the immediately preceding completed forward propagation training, backpropagation training, or parameter update processing. As a result, the parallel distributed machine learning system 1 can restart the machine learning from a state closer to the time point when the process abnormality occurs, than the check point.

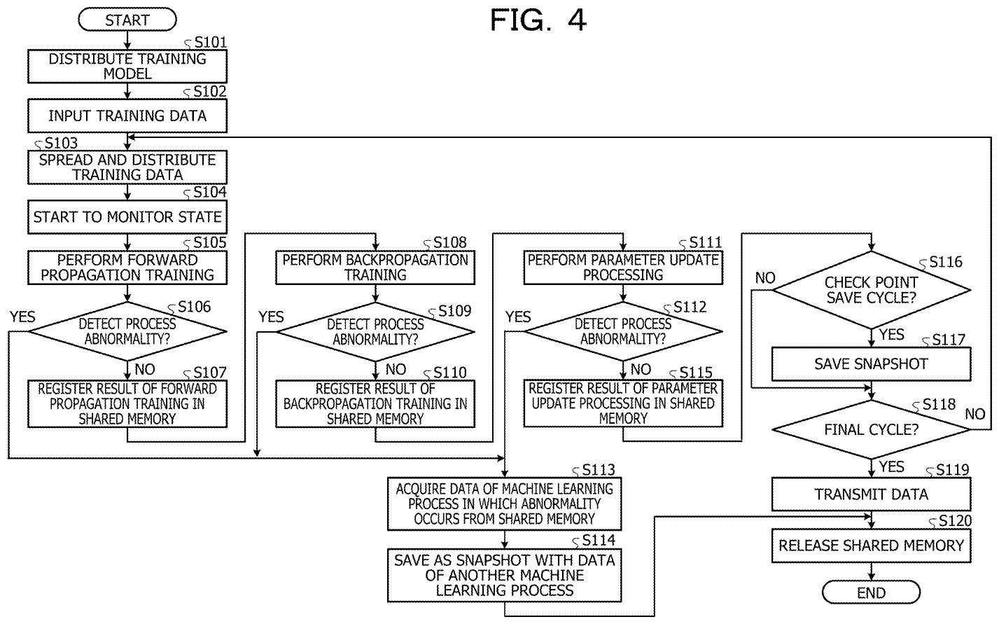

FIG. 4 is a flowchart of machine learning by the parallel distributed machine learning system according to the embodiment. Next, a flow of processing of the machine learning by the parallel distributed machine learning system 1 according to the present embodiment will be described with reference to FIG. 4.

The management node 20 transmits and distributes a machine learning model to be trained to each calculation node 10 (step S101).

Next, the management node 20 receives input of training data from a user (step S102).

Then, the management node 20 divides the training data and spreads and distributes the training data to each calculation node 10 (step S103).

The abnormality detection unit 104 starts to monitor a state of a machine learning process executed by the training execution unit 113 that shares the shared memory 120 (step S104).

The training execution unit 103 performs forward propagation calculation and forward propagation training using the machine learning model and the training data (step S105).

The abnormality detection unit 104 determines whether or not a process abnormality of the machine learning process executed by the processor 112 is detected while the forward propagation training is performed by the training execution unit 113 (step S106). In a case where the process abnormality is detected (step S106: Yes), the machine learning processing proceeds to step S113.

On the other hand, in a case where the process abnormality is not detected (step S106: No), after the forward propagation training is completed, the training execution unit 103 records information regarding a loss of forward propagation that is a result obtained through the forward propagation training, in the shared memory 120 (step S107).

Next, the training execution unit 103 performs backpropagation calculation and backpropagation training using the machine learning model and the results of the forward propagation training (step S108).

The abnormality detection unit 104 determines whether or not a process abnormality of the machine learning process executed by the processor 112 is detected while the backpropagation training is performed by the training execution unit 113 (step S109). In a case where the process abnormality is detected (step S109: Yes), the machine learning processing proceeds to step S113.

On the other hand, in a case where the process abnormality is not detected (step S109: No), after the backpropagation training is completed, the training execution unit 103 records information regarding a gradient of backpropagation that is a result obtained through the backpropagation training in the shared memory 120 (step S110).

Next, the training execution unit 103 communicates with the training execution unit 113 of the own node and the training execution units 103 and 113 of another calculation node 10 and shares the results of the forward propagation training and the backpropagation training. Thereafter, the training execution unit 103 executes the parameter update processing such as update of the model parameter of the machine learning model, using the shared results of the forward propagation training and the backpropagation training (step S111).

The abnormality detection unit 104 determines whether or not a process abnormality of the machine learning process executed by the processor 112 is detected while the parameter update processing is executed by the training execution unit 113 (step S112). In a case where the process abnormality is detected (step S112: Yes), the machine learning processing proceeds to step S113.

Here, in a case where the process abnormality is detected (step S106, S109, or S112: Yes), the abnormality detection unit 104 acquires data of the machine learning process executed by the processor 112 in which an abnormality has occurred, from the shared memory 120 (step S113). For example, in a case where the process abnormality is detected while the forward propagation training is performed, the abnormality detection unit 104 acquires data regarding an optimizer state and a model parameter of a cycle that is a one preceding cycle of the current cycle. Furthermore, the abnormality detection unit 104 acquires, from the shared memory 120, the data regarding the loss of the forward propagation in a case where the process abnormality is detected while the backpropagation training is performed and the data regarding the gradient of the backpropagation when the process abnormality is detected while the parameter update processing is executed. Note that, in a case where the process abnormality is detected while the forward propagation training is performed in the first cycle, the data of the machine learning process is not registered in the shared memory 120. Therefore, the machine learning processing returns to step S103.

Next, the abnormality detection unit 104 generates a snapshot of the machine learning model in the processor 112 at the time immediately before the abnormality occurrence, using the data of the machine learning process executed by the processor 112 and the machine learning model. Furthermore, the abnormality detection unit 104 acquires the data of the machine learning process executed by the processor 102 from the shared memory 120 and generates the snapshot of the machine learning process in the processor 102. Thereafter, the abnormality detection unit 104 saves the snapshot of the machine learning model held by each of the processors 102 and 112 in the storage device 30. Furthermore, the abnormality detection units 104 and 114 of another calculation node 10 generate snapshots of the machine learning models of the respectively corresponding processors 102 and 112 and save the snapshots in the storage device 30. For example, the parallel distributed machine learning system 1 generates each snapshot by combining the data of the machine learning process in which the abnormality has occurred and the data of the another machine learning process and saves the snapshot in the storage device 30 (step S114). Thereafter, the machine learning processing proceeds to step S120.

On the other hand, in a case where the process abnormality is not detected (step S112: No), after the parameter update processing is completed, the training execution unit 103 records the optimizer state and the model parameter that are results of the parameter update processing in the shared memory 120 (step S115).

When the forward propagation training, the backpropagation training, and the parameter update processing are completed, the training execution unit 103 determines whether or not a check point save cycle has arrived (step S116).

In a case where the check point save cycle has not arrived (step S116: No), the machine learning processing proceeds to step S118.

On the other hand, in a case where the check point save cycle has arrived (step S116: Yes), the training execution unit 103 saves the generated snapshot of the machine learning model in the storage device 30 (step S117). Note that, in a case where the process abnormality is detected while the forward propagation training is performed in n-th and subsequent (n≥2) cycles, in a case where a snapshot after the training in the n−1-th cycle has been performed is saved in the storage device 30, the abnormality detection unit 104 may acquire the snapshot.

Thereafter, the training execution unit 103 determines whether or not a final cycle of the machine learning has arrived (step S118). In a case where the final cycle of the machine learning has not arrived (step S118: No), the machine learning processing returns to step S103.

On the other hand, in a case where the final cycle of the machine learning has arrived (step S118: Yes), the training execution unit 103 ends the machine learning. Thereafter, the training execution unit 103 transmits data of the trained machine learning model to the management node 20 (step S119).

Thereafter, the training execution unit 103 releases the shared memory 120 (step S120).

Here, in the present embodiment, in a case where a process abnormality occurs in one machine learning process, the parallel distributed machine learning system 1 stops all the machine learning processes and restarts training from the time point when the snapshot is generated. However, the present embodiment is not limited to this. The parallel distributed machine learning system 1 may restart the machine learning process in which the process abnormality has occurred, without stopping the machine learning process in which the process abnormality does not occur. In that case, the training execution unit 103 may restart training from the time point when the snapshot is generated, using the snapshot generated at the immediately preceding time point. Furthermore, in that case, the training execution unit 103 can restart training using the data stored in the shared memory 120.

Moreover, in the present embodiment, an example of a case of the process abnormality has been described. However, in a case where an abnormality occurs in the processors 102 and 112, the training execution unit 103 can restart the machine learning using the snapshot generated at the immediately preceding time point.

As described above, each machine learning process in the parallel distributed machine learning system according to the present embodiment stores the data obtained through the machine learning so far after the end of each of the forward propagation training, the backpropagation training, and the parameter update processing, in the shared memory. Then, in a case where a process abnormality occurs in a specific machine learning process, a machine learning process that shares the shared memory with the specific machine learning process acquires data of the specific machine learning process in which the process abnormality has occurred, from the shared memory. Then, the machine learning process that shares the shared memory with the specific machine learning process generates a snapshot at the time point immediately before the abnormality occurrence from the acquired data and stores the snapshot in an external storage. At this time, regarding another machine learning process in which a process abnormality does not occur, a snapshot at the time point immediately before the same abnormality occurrence is generated and is stored in the external storage.

As a result, the parallel distributed machine learning system can restart the machine learning from the time point when the forward propagation training, the backpropagation training, or the parameter update processing ends that is the closest from the time point when the process abnormality has occurred. Therefore, it is possible to restart the machine learning from the time point closer to the time point when the process abnormality has occurred than the check point, without providing a large number of check points and saving a large number of snapshots, and it is possible to shorten an entire training time and reduce cost. For example, training efficiency of the machine learning can be improved.

### (Hardware Configuration)

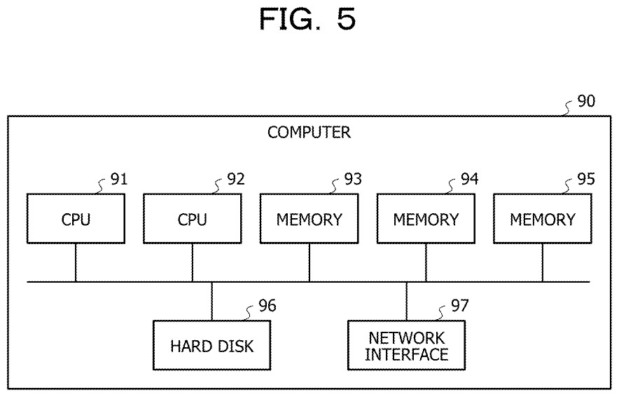

FIG. 5 is a hardware configuration diagram of a computer. The calculation node 10 illustrated in FIG. 1 is implemented, for example, by a computer 90 illustrated in FIG. 5. As illustrated in FIG. 5, the computer 90 includes central processing units (CPU) 91 and 92, memories 93 to 95, a hard disk 96, and a network interface 97. The CPUs 91 and 92 are coupled to the memories 93 to 95, the hard disk 96, and the network interface 97 via a bus.

The network interface 97 is an interface for communication between the computer 90 and an external device. The network interface 97 relays communication between the CPUs 91 and 92 and the another calculation node 10, the management node 20, and the storage device 30, for example.

The hard disk 96 is an auxiliary storage device. The hard disk 96 stores various programs including a program that implements functions of the training execution units 103 and 113 and the abnormality detection units 104 and 114 illustrated in FIG. 1.

The memories 93 to 95 are main storage devices. The memories 92 to 95 can use, for example, a dynamic random access memory (DRAM). The memory 93 implements the function of the individual memory 101 illustrated in FIG. 1. Furthermore, the memory 94 implements the function of the individual memory 111 illustrated in FIG. 1. Furthermore, the memory 95 implements the function of the shared memory 120 illustrated in FIG. 1. Furthermore, the memories 93 to 95 may be different regions in a single memory.

The CPU 91 is an example of the processor 102 illustrated in FIG. 1. The CPU 91 reads various programs from the hard disk 96, and expands the read programs in the memory 93 to execute the expanded programs. As a result, the CPU 91 can implement the functions of the training execution unit 103 and the abnormality detection unit 104 illustrated in FIG. 1.

The CPU 92 is an example of the processor 112 illustrated in FIG. 1. The CPU 92 reads various programs from the hard disk 96, and expands the read programs in the memory 94 to execute the expanded programs. As a result, the CPU 92 can implement the functions of the training execution unit 113 and the abnormality detection unit 114 illustrated in FIG. 1.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program for causing a computer to execute processing comprising:
causing each of a plurality of machine learning processes to perform individual machine learning by the same machine learning model;
storing data after execution of first processing by each of the machine learning processes in a shared memory accessible by each of the machine learning processes; and
causing a second machine learning process other than the first machine learning process among the plurality of machine learning processes to execute second processing regarding the first machine learning process, based on first data after the execution of the first processing regarding the first machine learning process, stored in the shared memory, in a case where an abnormality occurs at the time of execution of the second processing executed after the first processing by the first machine learning process among the machine learning processes.

2. The non-transitory computer-readable recording medium according to claim 1, wherein in the processing of storing in the shared memory, the first data is stored in a first shared memory associated with the first machine learning process from among one or more shared memories associated with each of the plurality of machine learning processes.

3. The non-transitory computer-readable recording medium according to claim 2, for causing the computer to execute processing further comprising:
in the execution of the second processing based on the data after the first processing has been executed in a case where the abnormality has occurred,
acquiring the data after the first processing has been executed stored in the first shared memory that corresponds to the first machine learning process in which the abnormality has occurred;
generating a snapshot of the machine learning model, based on the acquired data after the first processing has been executed and storing the snapshot in a storage device; and
causing the second machine learning process to execute the second processing by using the snapshot stored in the storage device.

4. The non-transitory computer-readable recording medium according to claim 1, for causing the computer to execute any one of forward propagation training, backpropagation training, or parameter update processing of the machine learning model, as the first processing.

5. The non-transitory computer-readable recording medium according to claim 4, for causing the computer to execute processing comprising:
storing a loss of forward propagation in the shared memory as the data after the first processing has been executed, in a case where the forward propagation training is performed as the first processing;
storing a gradient of backpropagation in the shared memory as the data after the first processing has been executed, in a case where the backpropagation training is performed as the first processing; and
storing an optimizer state and a model parameter in the shared memory as the data after the first processing has been executed, in a case where the parameter update processing is executed as the first processing.

6. A machine learning method comprising:
causing each of a plurality of machine learning processes to perform individual machine learning by the same machine learning model;
storing data after execution of first processing by each of the machine learning processes in a shared memory accessible by each of the machine learning processes; and
causing a second machine learning process other than the first machine learning process among the plurality of machine learning processes to execute second processing regarding the first machine learning process, based on first data after the execution of the first processing regarding the first machine learning process, stored in the shared memory, in a case where an abnormality occurs at the time of execution of the second processing executed after the first processing by the first machine learning process among the machine learning processes.

7. A machine learning device comprising:
a plurality of processors each of which configured to operate a plurality of machine learning processes each of which performs individual machine learning by the same machine learning model;
a plurality of individual memories configured to correspond to each of the processors; and
a shared memory configured to be accessible from each of the plurality of processors, wherein
each of the processors:
detects an abnormality in the machine learning process operated by another processor that shares the shared memory among the machine learning processes, and
executes the machine learning process by using the individual memory, stores data after execution of first processing of the machine learning process in the shared memory, and causes a second machine learning process other than the first machine learning process among the plurality of machine learning processes to execute second processing regarding the first machine learning process, based on first data after the execution of the first processing regarding the first machine learning process, stored in the shared memory, in a case where an abnormality is detected by the abnormality detection unit at the time of execution of second processing executed after the first processing by the first machine learning process among the machine learning processes operated by the another processor that shares the shared memory.
